(19) United States
(12) Patent Application Publication
(10) Pub. No.: US 2011/0278342 A1
(43) Pub. Date: Nov. 17, 2011

(54) NAIL GUN WITH IMPROVED ATTACHABLE AND DETACHABLE MAGAZINE ASSEMBLY

(75) Inventor: Lun-Hung Kuo, Taipei County (TW)

(73) Assignee: DE POAN PNEUMATIC CORP., Bali Township (TW)

(21) Appl. No.: 12/780,930

(22) Filed: May 17, 2010

(51) Int. Cl. B25C 1/00

(52) U.S. Cl. 227/120

(57) ABSTRACT

The present invention relates to a nail gun with an improved attachable and detachable magazine assembly, comprising: a nail gun, a magazine assembly and an attach and detach mechanism. A handle portion of the nail gun has a joining pillar capable of joining with the attach and detach mechanism for attaching the magazine assembly with the nail gun, wherein the attach and detach mechanism further comprises: a fixing frame, a swinging fastening bar, a fastening member, and an elastic element. When it is desired to attach the joining pillar with the magazine assembly, the swinging fastening bar must be swung out firstly, so as to insert the joining pillar into the fixing frame, and continuously, to swing the swinging fastening bar close to the fixing frame, furthermore, then the fastening notch is able to grip and fix the joining pillar inside the fixing frame, finally, the joining pillar is completely attached with the magazine assembly.

### BACKGROUND OF THE INVENTION

1. Technical Field

The present invention relates to a nail gun, and more particularly, to a nail gun with an improved attachable and detachable magazine assembly, which is provided with an attach and detach mechanism, so that a magazine assembly is easily to be attached to and detached from the nail gun through the attach and detach mechanism.

2. Description of Related Art

As a kind of tool indispensable to decoration workers, a nail gun has a magazine for accommodating a strip of nails. Conventionally, the magazine is mostly bolted to a handle portion of the nail gun, and a top portion of the magazine engages with a nosepiece of the nail gun to guide nails from the strip of nails into the nosepiece one by one so as to be further drove through the nosepiece.

The essential shortcoming of the conventional nail gun described above is that when it is desired to detach the magazine from the nail gun, detach tools must be used to finish the detachment, for this reason; that is very inconvenient when using the conventional nail gun. For overcoming the main shortcoming of the conventional nail gun, inventors positively do kinds of researches and create variety improved nail guns, such as a device for rapid magazine detachment on a nail gun is disclosed in Taiwan Patent Application No. 096115283, an exploded view of which is illustrated in FIG. 1. The device for rapid magazine detachment on a nail gun is a combination of a nail gun 11′ and a magazine 4′. The nail gun 11′ has a handle portion 12′, a nose piece 15′ and a trigger 14′. The handle portion 12′ is provided thereon with a pivot block 13′, to which a rod 2′ is pivoted. The rod 2′ is formed with a tapered portion 21′ at an end thereof, and an elastic element (the elastic element is not shown in FIG. 1) is inserted over the rod 2′ to drive the tapered portion 21′ to abut against the pivot block 13′.

Furthermore, in the device for rapid magazine detachment on a nail gun, the magazine 4′ is provided thereon with an engaging block 5′, which has an end groove 51′ and an embedding groove 52′ in communication with each other. The tapered portion 21′ of the rod 2′ is adapted to be inserted into the end groove 51′ and embedded into the bottom of the embedding groove 52′. A fastener 6′, which has an outer stopper piece 61′ and an inner stopper piece 62′, is pivoted between the engaging block 5′ and the magazine 4′. By swinging the fastener 6′ into the bottom of the embedding groove 52′, the tapered portion 21′ of the rod 2′ can be clamped by the outer stopper piece 61′ and the inner stopper piece 62′ cooperatively, with the outer stopper piece 61′ being used to block between the embedding groove 52′ and the end groove 51′. Thus, the tapered portion 21′ is restricted within the embedding groove 52′, thereby engaging the magazine 4′ with the nail gun 1′. Additionally, when it is desired to detach the magazine 4′ from the nail gun 11′, one must swing the fastener 6′ out of the bottom of the embedding groove 52′ to detach the magazine 4′. Once the magazine 4′ is detached, abnormal conditions of the nail gun 11′ such as sticking of nails can be cleared.

Additionally, other relevant nail gun products have also been provided in the market, for example, an assembled nail gun as disclosed in U.S. Pat. No. 6,609,646. Referring to FIGS. 2 and 3 together, a top view of the assembled nail gun, a snap-fit element and a snap-fit mount thereof are illustrated therein respectively. The assembled nail gun, which is a conventional product currently available in the market, is a combination of a nail gun 1a and a magazine 4a. The nail gun 1a has a handle portion 12a, a nose piece 15a and a trigger 14a. The handle portion 12a is provided thereon with a snap-fit mount 13a, which has a snap-fit rod 131a and a pull lever 132a. The magazine 4a is provided thereon with a snap-fit element 5a, which has an inserting hole 51a and a slot hole 52a. A user simply needs to insert the snap-fit rod 131a into the inserting hole 51a, push it into the slot hole 52a and then press the pull lever 132a downwards in order to engage the magazine 4a with the nail gun 1a. On the other hand, when it is desired to detach the magazine 4a from the nail gun 1a, the user simply needs to pull the pull lever 132a upwards and then move the snap-fit rod 131a out of the slot hole 52a and the inserting hole 51a sequentially, thereby detaching the magazine 4a.

The abovementioned nail guns all have the advantage of allowing the magazines to be attached to and detached from the nail guns without need of tools; however, the two nail guns respectively have shortcomings as follows:
1. For the device for rapid magazine detachment on the nail gun, that is, by swinging the fastener 6′ into the bottom of the embedding groove 52′, the tapered portion 21′ of the rod 2′ can be clamped by the outer stopper piece 61′ and the inner stopper piece 62′ cooperatively, with the outer stopper piece 61′ being used to block between the embedding groove 52′ and the end groove 51′. Thus, the tapered portion 21′ is restricted within the embedding groove 52′, thereby engaging the magazine 4′ with the nail gun 1′, a complex assemble procedures, so that the user can not attach the magazine 4′ to the nail gun 1′ easily.
2. It lacks a force to push the snap-fit rod 131a (or the rod 2′) when attaching the magazine 4a (4′) with the nail gun 1a (1′), so that, the top of the magazine 4a (4′) can not be connected to the nosepiece 15a (15′) tightly; further that, a small space is produced between the top of the magazine and the nosepiece, the small space often causes the situations of sending the nail irregularly and unsuccessfully when using the two nail guns described above.
3. For the assembled nail gun disclosed in U.S. Pat. No. 6,609,646, it accomplishes the purpose by snap-fitting the snap-fit rod 131a into the snap-fit element 5a and then pressing the pull lever 132a downwards to fix the snap-fit rod 131a, which design does not need a large force in attachment and detachment of the magazine 4a; however, as a plastic piece, the pull lever 132a tends to lose the ability of fixing the snap-fit rod 131a due to abrasion after repeated attachment and detachment of the magazine 4a, in which case the pull lever 132a must be replaced in order to secure the engagement of the magazine 4a with the nail gun 1a.

Accordingly, in view of the drawbacks and shortcomings of the aforesaid conventional nail guns, the inventor of the present application has made great efforts to make inventive research thereon and eventually provided a nail gun with an improved attachable and detachable magazine assembly according to the present invention.

### SUMMARY OF THE INVENTION

The primary objective of the present invention is to provide a nail gun with an improved attachable and detachable magazine assembly, in which an attach and detach mechanism is disposed on a magazine assembly, so that, the magazine assembly is able to easily be attached to or detached from the nail gun through the attach and detach mechanism, furthermore, the magazine assembly is connected to a nosepiece of the nail gun tightly for preventing from failing to sent a nail.

Accordingly, to achieve the abovementioned objective, the inventor proposes a nail gun with an improved attachable and detachable magazine assembly, which comprises a nail gun, a magazine assembly and an attach and detach mechanism. The nail gun has a handle portion which is formed with a joining portion at a side of a distal end thereof, and a joining pillar is disposed on the joining portion. The attach and detach magazine comprises: a fixing frame, a swinging fastening bar, a fastening member, and an elastic element, wherein the fixing frame is fastened on the magazine assembly; The swinging fastening bar comprises a close portion and a distant portion, the swinging fastening bar is fastened on the fixing frame via the close portion, moreover, the swinging fastening bar is swung through operating the distant portion; One end of the fastening member is formed with a fastening notch, when it is desired to attach the joining pillar with the magazine assembly, the swinging fastening bar must be swung out firstly so as to insert the joining pillar into the fixing frame, and continuously, to swing the swinging fastening bar close to the fixing frame, furthermore, the fastening notch is able to grip and fix the joining pillar inside the fixing frame; The elastic element is able to produce a force, wherein the fastening member further getting into the accommodation portion after the joining pillar is gripped by the fastening notch, the force pushes the fastening member so as to make the top of the magazine assembly be connected to the nosepiece tightly.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a top view of a device for rapid magazine detachment on a nail gun;

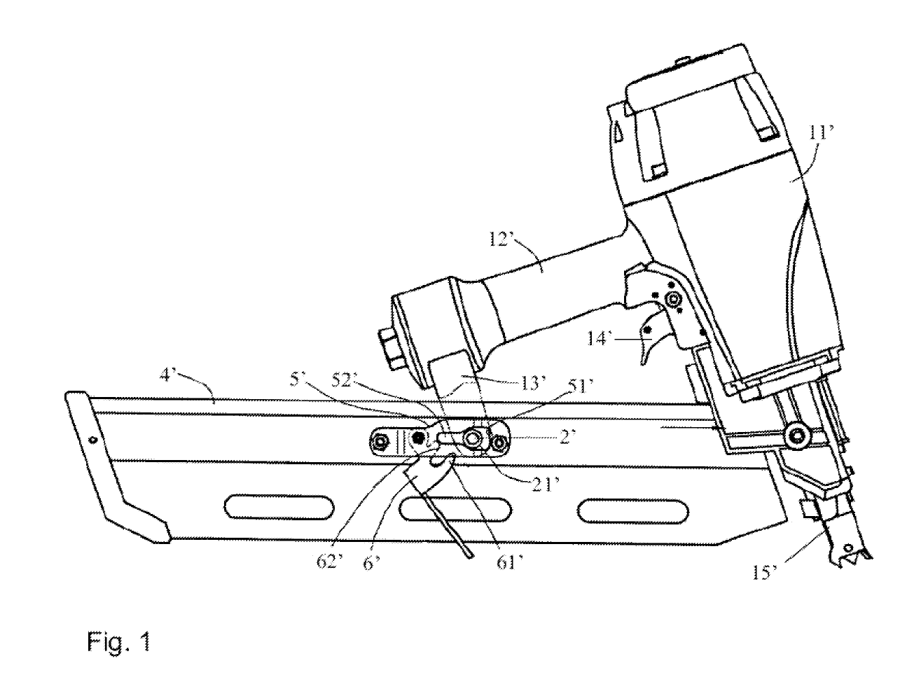

FIG. 2 is the top view of an assembled nail gun;

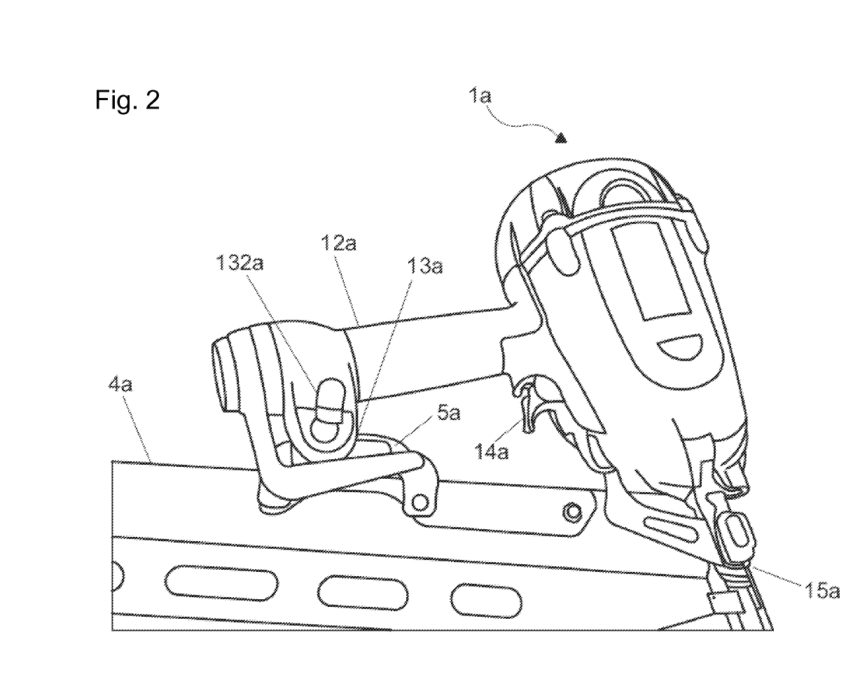

FIG. 3 is a top view of a snap-fit element and a snap-fit mount of the combined nail gun;

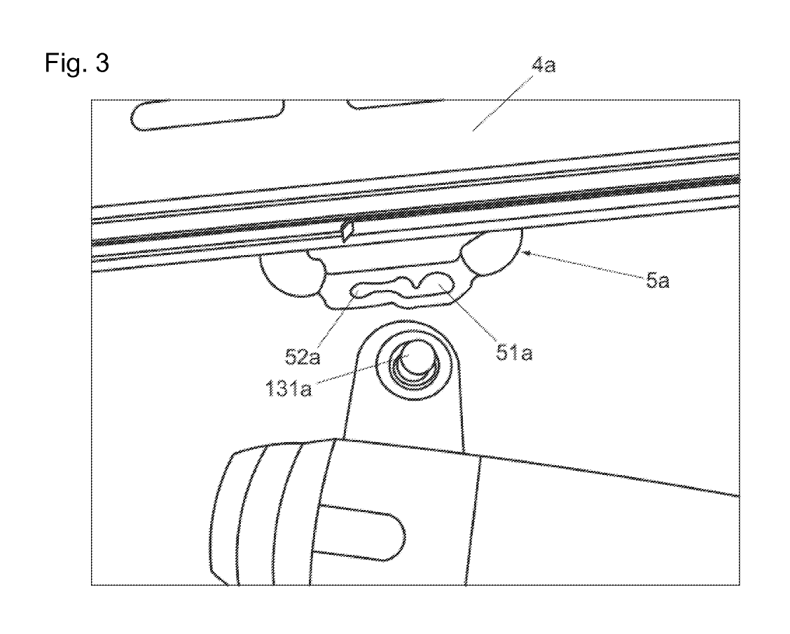

FIG. 4 is a partial exploded view of a nail gun with an improved attachable and detachable magazine assembly according to the present invention;

FIG. 5 is a cross section view of the nail gun with the improved attachable and detachable magazine assembly;

FIG. 6 is the exploded view of an attach and detach mechanism of the nail gun with the improved attachable and detachable magazine assembly; and

FIG. 7 is view illustrating subdivided actions of inserting the joining pillar into the attach and detach mechanism.

### DETAILED DESCRIPTION OF THE INVENTION

To more clearly describe a nail gun with an improved attachable and detachable magazine assembly according to the present invention, an embodiment of the present invention will be described in detail with reference to the attached drawings hereinafter.

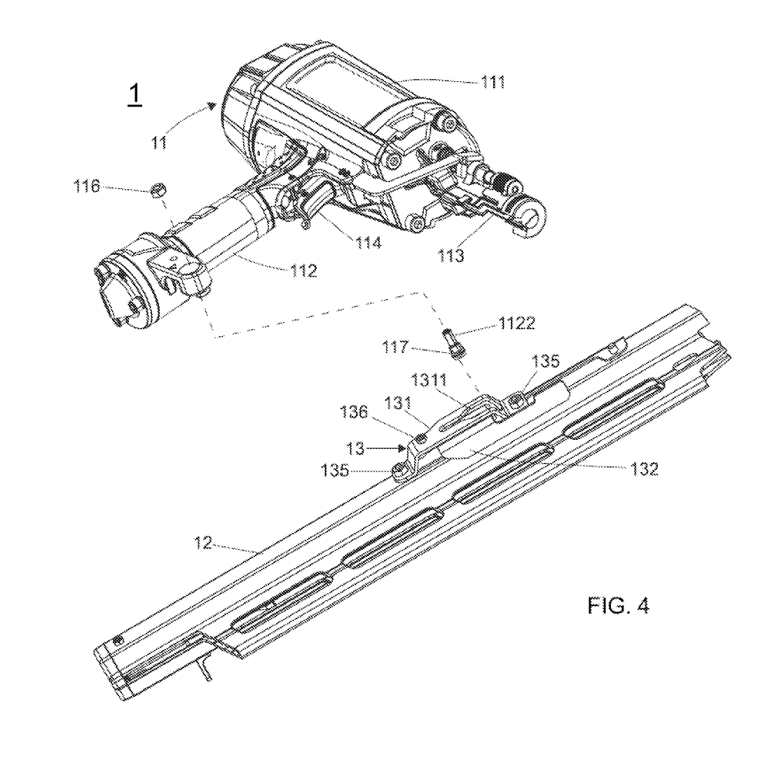

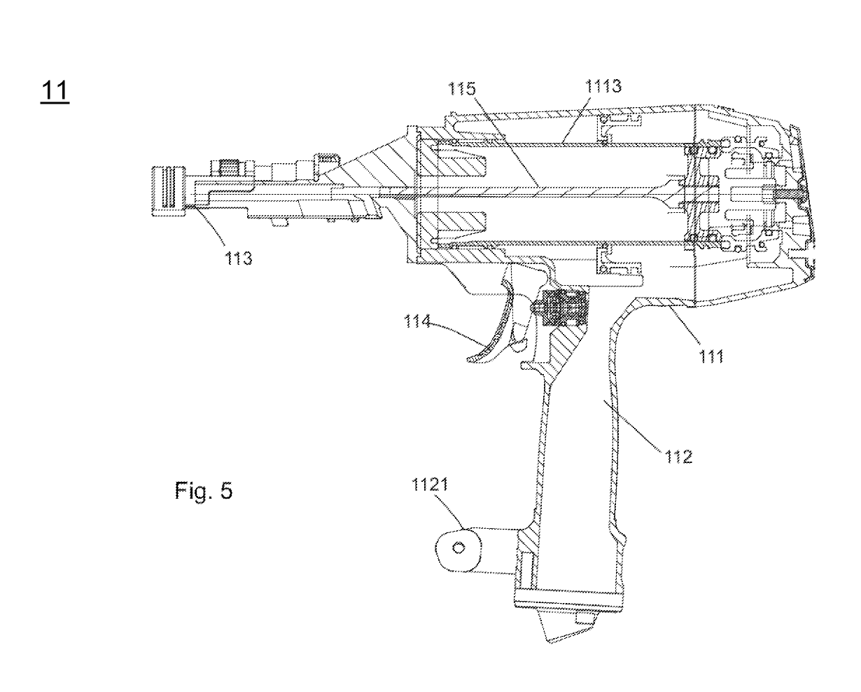

Referring to FIGS. 4 and 5 together, which respectively illustrate a partial exploded view of the nail gun with the improved attachable and detachable magazine assembly and a cross section view of the nail gun according to the present invention, the nail gun with the attachable and detachable magazine assembly 1 includes: a nail gun 11; a magazine assembly 12, which is connected to the nail gun 11 for providing the nail gun 11 with a nail; and an attach and detach mechanism 13 disposed on the magazine assembly 12, wherein the magazine assembly 12 is able to be attached with the nail gun 11 through the attach and detach mechanism 13. The nail gun 11 includes: a gun body 111, a nosepiece 113, a nail driving element 115, a handle portion 112, a trigger 114, a joining pillar nut 116, and a joining pillar sleeve 117.

Referring to FIGS. 4 and 5 again, the nosepiece 113 is connected to the gun body 111 and capable of accommodating the nail; The nail driving element 115 is adapted to drive the nail accommodated in the nosepiece 113; The handle portion 112 is connected with the gun body 111 for holding and formed with a joining portion 1121 at a side of a distal end thereof, moreover, a joining pillar 1122 is fastened on the joining portion 1121 through the joining pillar nut 116, then the magazine assembly 12 can be attached to the nail gun 11 by way of combining the joining pillar 1122 with the attach and detach mechanism 13; The trigger 114 is disposed between the gun body 111 and the handle portion 112, wherein the nail driving element 115 is triggered to force the nail accommodated in the nosepiece 113 when the trigger 114 is pressed; The joining pillar sleeve 117 is adapted to sheath the joining pillar 1122, the outer shape of the joining pillar sleeve 117 is able to closely meet the fastening notch so as to make the joining pillar 1122 be intimately fastened by an internal element of the attach and detach mechanism 13.

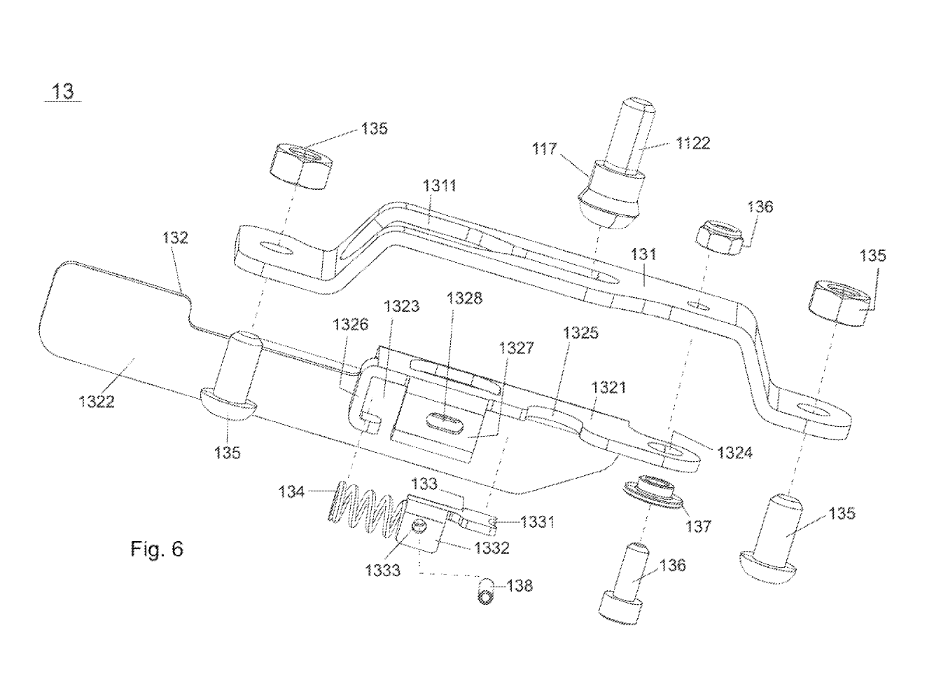

Referring to FIG. 5, and concurrently referring to FIG. 6, which illustrates an exploded view of the attach and detach mechanism of the nail gun with the improved attachable and detachable magazine assembly. The attach and detach mechanism described above is used to facilitate the combination of the magazine assembly 12 and the nail gun 11, and includes: a fixing frame 131, a swinging fastening bar 132, a fastening member 133, an elastic element 134, two first screw-and-nut assemblies 135, a second screw-and-nut module 136, a washer type pivot 137, and a dowel-pin 138. Wherein the fixing frame 131 is secured on the magazine assembly 12 and has an aperture 1311, the joining pillar 1122 is inserted into the fixing frame 131 via the aperture 1311; The swinging fastening bar 132 is fastened on the fixing frame 131 and has a close portion 1321 and a distant portion 1322, one end of the close portion 1321 is formed with an accommodation portion 1323 having a bottom portion 1326 and two side portions 1327, wherein the bottom portion 1326 is adapted to fix the elastic element 134 at a relative position in the accommodation portion 1323, the two side portions 1327 respectively have a dowel-pin opening 1328 for inserting the dowel-pin 138, respectively; Moreover, the swinging fastening bar is fastened on the fixing member 131 via the close portion 1321 and capable of being swung by operating the distant portion 132.

Continuously referring to FIG. 5 and FIG. 6 together, the fastening member 133 is disposed in the accommodation portion 1323 and has one end formed a fastening notch 1331 and protruding out of the accommodation portion 1323, moreover, one end of the fastening member 133 opposite to the forming end of the fastening notch 1331 is downwardly formed two fixing portions 1332, which respectively have a dowel-pin opening 1333. When it is desired to attach the joining pillar 1122 with the attach and detach mechanism 13, the swinging fastening bar 132 must be swung out firstly so as to insert the joining pillar 1122 into the fixing frame 131 via the aperture 1311, and then, to swing the swinging fastening bar 132 close to the fixing frame 131, meanwhile, the fastening notch 1331 is able to grip and fix the joining pillar 1122 inside the fixing frame 131. The elastic element 134 is a compression spring and disposed in the accommodation portion 1323 opposite to the forming end of the fastening notch 1331 of the fastening member 133, wherein the fastening member 133 is back into the accommodation portion after the joining pillar 1122 being gripped by the fastening notch 1331, meanwhile, the elastic element 134 produces a force to push the fastening member 133 after the fastening notch griping the joining pillar 1122, so that, by way of pushing from the force, the joining pillar 1122 is steadily fixed in fixing member and the top of the magazine assembly 12 is further connected to the nosepiece 13 tightly. So that, from the above-mentioned, it is know that, through disposing the attach and detach mechanism 13 on the magazine assembly 12, not only the joining pillar being fixed inside the fixing frame steadily but also the top of the magazine assembly being connected to the nosepiece tightly, so as to prevent from the failure of sending a nail.

Referring to FIG. 5 and FIG. 6 again, for the attach and detach mechanism 13 described above, the two first screw-and-nut assemblies 135 are adapted to secure the fixing frame 131 onto the magazine assembly 12; The second screw-and-nut module 136 is used to secure the swinging fastening bar 132 onto the fixing frame 131; The washer type pivot 137 is disposed between the close portion 1321 and the fixing frame 131, wherein the washer type pivot 137, swinging fastening bar 132 and the fixing frame 131 can be fastened together through the second screw-and nut assembly 136, so that, the swinging fastening bar 132 is able to be swung by operating the distant portion 1322 and disposing the washer type pivot 137 between the close portion 1321 and the fixing frame 131; Finally, The dowel-pin 138 is adapted to inset and fix the fastening member 133 into the accommodation portion 1323 via the two dowel-pin opening 1333 of the two fixing portion 1332, the dowel-pin 138 and the fixing member 133 can be moved a distance by way of the dowel-pin opening 1328.

Referring to FIG. 5 and FIG. 6 again, for the attach and detach mechanism 13 described above, the close portion 1321 has a screw hole 1324 and a notch 1325, wherein the screw hole 1324 is formed at one end of the close portion 1321 opposite to the forming end of the accommodation portion 1323, the second screw-and-nut module 136 is adapted to secure the swinging fastening bar 132 onto the fixing frame 131 through the screw hole 1324; The notch 1325 is formed between the accommodation portion 1323 and the screw hole 1324 and is able to contain the joining pillar 1122 when the joining pillar 1122 is inserted into the fixing frame 131.

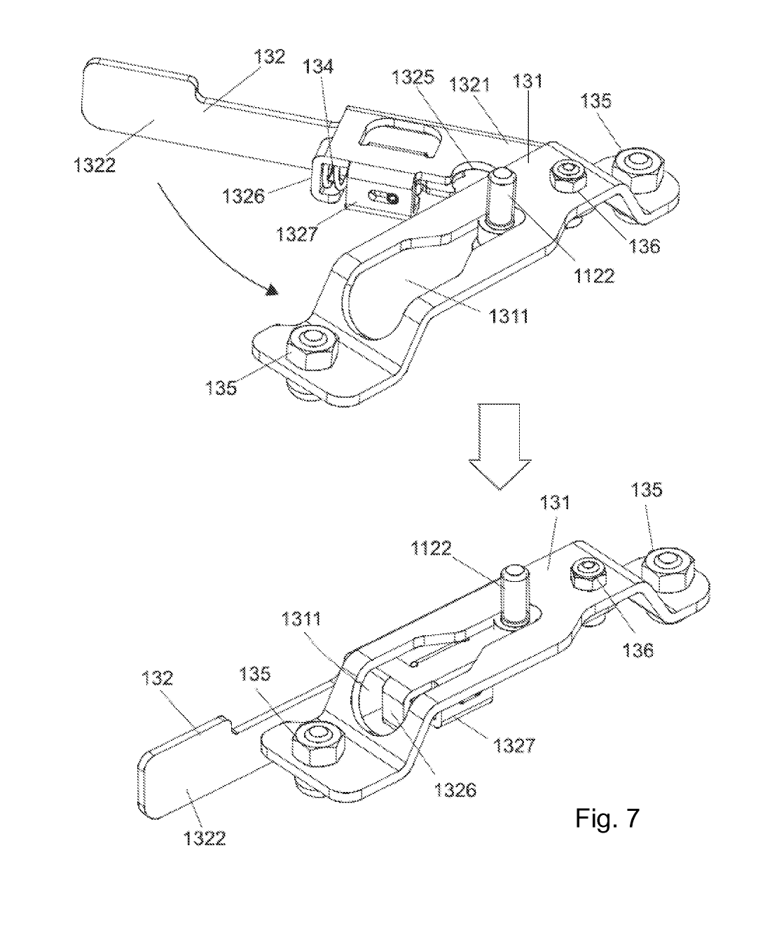

For more clearly describing how to insert the joining pillar 1122 into the attach and detach mechanism 13 for combination, referring to FIG. 7, which is view illustrating subdivided actions of inserting the joining pillar into the attach and detach mechanism. When a user uses the nail gun with the improved attachable and detachable magazine assembly 1 and desires to attach the magazine assembly 12 with the nail gun 11, the user needs to attach the joining pillar 1122 with the attach and detach mechanism 13: as shown in FIG. 7, Firstly, the swinging fastening bar 132 must be swung out so as to insert the joining pillar 1122 into the fixing frame 131, and then, as shown in FIG. 7, to swing the swinging fastening bar 132 close to the fixing frame 131 for making the fastening notch 1331 grip and fix the joining pillar 1122 inside the fixing frame 131, thereafter, the magazine assembly 12 is easily to be attached with the nail gun 11. Besides, when it is desired to detach the magazine assembly 12 from the nail gun 11, it must to separates the joining pillar 1122 from the attach and detach mechanism 13: Firstly, to swing out the swinging fastening bar, and then, to separate the joining pillar 1122 from the fixing frame 131, so that, the joining pillar 1122 has been separated from the attach and detach mechanism 13, thereafter, the magazine assembly 12 is easily to be detached from the nail gun 11.

Thus, the nail gun according to the present invention has been disclosed above completely and clearly. In summary, the present invention has the following advantages:
1. The user can easily attach the magazine assembly with the nail gun by way of inserting the joining pillar into the attach and detach mechanism without complex assembling procedures; moreover, the user can easily detach the magazine assembly from the nail gun by way of taking the joining pillar out of the attach and detach mechanism without complex disassembling procedures.
2. By way of pushing the fastening member through the force produced from the elastic element, not only the joining pillar being fixed inside the fixing frame steadily but also the top of the magazine assembly being connected to the nosepiece tightly, so that the situation of the small space causing the nail is sent irregularly and unsuccessfully when driving nails is able to be avoided.

The above description is made on an embodiment of the present invention. However, this embodiment is not intended to limit scope of the present invention, and all equivalent implementations or alterations within the spirit of the present invention still fall within the scope of the present invention.

I claim:

1. A nail gun with an improved attachable and detachable magazine assembly, comprising:
a nail gun, comprising:
a gun body;
a nosepiece, being connected to the gun body and adapted to accommodate a nail;
a nail driving element, being disposed inside the gun body and adapted to drive the nail accommodated in the nosepiece;
a handle portion, being connected with the gun body for holding and formed with a joining portion at a side of a distal end thereof, wherein a joining pillar is disposed on the joining portion; and
a trigger, being disposed between the gun body and the handle portion, wherein the nail driving element is activated to force the nail accommodated in the nosepiece when the trigger is pressed;
a magazine assembly, being adapted to connect with the nail gun to supply the nail gun with the nails; and
an attach and detach mechanism, being disposed on the magazine assembly, so that the magazine assembly is attached to the nail gun through engagement of the attach and detach mechanism with the joining pillar, the attach and detach mechanism comprising:
a fixing frame, being fastened onto the magazine assembly and having an aperture, the joining pillar being able to inserted into the fixing frame via the aperture;
a swinging fastening bar, being disposed on the fixing frame and having a close portion and a distant portion, one end of the close portion being formed an accommodation portion, wherein the swinging fastening bar is disposed on the fixing frame via the close portion and capable of being swung by way of operating the distant portion;
a fastening member, being disposed in the accommodation portion and having an end formed a fastening notch and protruding out of the accommodation portion, when it is desired to attach the joining pillar with the magazine assembly, the swinging fastening bar must being swung out firstly, so as to insert the joining pillar into the fixing frame and continuously, to swing the swinging fastening bar close to the fixing frame, further that, the fastening notch being able to grip and fix the joining pillar inside the fixing frame; and
an elastic element, being disposed in the accommodation portion and being opposite to the forming end of the fastening notch of the fastening member, wherein the fastening member is back into the accommodation portion after the joining pillar being gripped by the fastening notch, meanwhile, a force being produced by the elastic element and pushing the fastening member, further that, not only the joining pillar being fixed inside the fixing frame steadily but also the top of the magazine assembly being connected to the nosepiece tightly.

2. The nail gun with the improved attachable and detachable magazine assembly of claim 1, wherein the nail gun further comprises:
a joining pillar nut, being adapted to secure the joining pillar onto the joining portion; and
a joining pillar sleeve, being adapted to sheath the joining pillar, the outer shape of the joining pillar sleeve being able to closely meet the fastening notch, so that the fastening notch can closely grip the joining pillar via the joining pillar sleeve.

3. The nail gun with the improved attachable and detachable magazine assembly of claim 1, wherein the attach and detach mechanism further comprises:
two first screw-and-nut assemblies, being adapted to secure the fixing frame onto the magazine assembly;
a second screw-and-nut module, being used to secure the swinging fastening bar onto the fixing frame;
a washer type pivot, being disposed between the close portion and the fixing frame, wherein the washer type pivot, swinging fastening bar and the fixing frame can be fastened together through the second screw-and nut assembly, so that, by way of disposing the washer type pivot between the close portion and the fixing frame, the swinging fastening bar being able to be swung when operating the distant portion; and
a dowel-pin, being adapted to insert and fix the fastening member into the accommodation portion.

4. The nail gun with the improved attachable and detachable magazine assembly of claim 3, wherein the close portion further comprises:
a screw hole, being formed at one end of the close portion opposite to the forming end of the accommodation portion, wherein the second screw-and-nut module is able to secure the swinging fastening bar onto the fixing frame via the screw hole; and
a second screw-and-nut module, being used to secure the swinging fastening bar onto the fixing frame;
a notch, being formed between the accommodation portion and the screw hole, and being able to contain the joining pillar when the joining pillar is inserted into the fixing frame.

5. The nail gun with the improved attachable and detachable magazine assembly of claim 1, wherein two fixing portions are formed at one end of the fastening member opposite to the forming end of the fastening notch, and each of the two fixing portions having a dowel-pin hole respectively.

6. The nail gun with the improved attachable and detachable magazine assembly of claim 3, wherein the accommodation portion further comprises a bottom potion and two side portions, the bottom portion being adapted to fix the elastic element at a relative position in the accommodation portion, each of the two side portions having a dowel-pin opening for inserting the dowel-pin respectively.

7. The nail gun with the improved attachable and detachable magazine assembly of claim 1, wherein the elastic element is a compression spring.
